(19) United States
(12) Patent Application Publication
(10) Pub. No.: US 2023/0290137 A1
(43) Pub. Date: Sep. 14, 2023

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventors: HIROTAKA ISHIKAWA, TOKYO (JP); SATOSHI WATANABE, KANAGAWA (JP); YOSHIMI OGAWA, KANAGAWA (JP); KOTA YONEZAWA, KANAGAWA (JP); YOSHIHIRO KUMAGAI, KANAGAWA (JP); HIDEKI ANDO, KANAGAWA (JP)

(21) Appl. No.: 18/002,680

(22) PCT Filed: Jun. 17, 2021
(86) PCT No.: PCT/JP2021/023053

§ 371 Date: Dec. 21, 2022

(30) Foreign Application Priority Data
Jul. 1, 2020 (JP) 2020-113756

(51) Int. Cl. G06V 10/70; G06V 10/74

(52) U.S. Cl. CPC G06V 10/87; G06V 10/761

(57) ABSTRACT

The present technology relates to an information processing apparatus, an information processing method, and a program that enable processing with maintained accuracy to be performed using a recognition model according to a noise level.

A model switching unit that switches a recognition model according to an amount of noise of an imaged image is provided, and the model switching unit switches between a first recognition model trained with an image without noise and a second recognition model trained with an image with noise. The recognition model is used for processing by an AI function. It is applicable to, for example, a system including a surveillance camera and a server that distributes data from the surveillance camera.

### TECHNICAL FIELD

The present technology relates to an information processing apparatus, an information processing method, and a program, and for example, relates to an information processing apparatus, an information processing method, and a program that enable processing with a recognition model suitable for a situation.

### BACKGROUND ART

In recent years, surveillance cameras and the like have been installed on streets, and moreover, vehicle-mounted cameras capable of capturing images of a surrounding environment of a traveling vehicle are also mounted on the vehicle such that captured images in various places can be easily acquired. Furthermore, the surveillance cameras and the like analyze captured images to detect people or recognize a specific person.

Patent Document 1 discloses that a subject detection process is performed using different parameters according to the amount of blurring and the definition of an image imaged by a camera in order to maintain the accuracy of detection, for example, in a case where a person is detected by analyzing the imaged image or the like. Furthermore, Patent Document 2 describes that a model is selected depending on which task is to be analyzed.

### CITATION LIST

### Patent Document

Patent Document 1: Japanese Patent Application Laid-Open No. 2019-186911
Patent Document 2: Japanese Patent Application National Publication (Laid-Open) No. 2018-510399

### SUMMARY OF THE INVENTION

### Problems to be Solved by the Invention

For example, when processing of detecting a person from an imaged image is executed by an artificial intelligence (AI) function, there is a possibility that the accuracy of the processing is different between an image with noise and an image without noise. It is desired to prevent such a difference in the processing accuracy.

The present technology has been made in view of such a situation, and an object thereof is to enable prevention of a difference in processing accuracy.

### Solutions to Problems

An information processing apparatus according to one aspect of the present technology includes a model switching unit that switches a recognition model according to the amount of noise of an imaged image, in which the model switching unit switches between a first recognition model trained with an image without noise and a second recognition model trained with an image with noise.

An information processing method according to one aspect of the present technology includes switching, by an information processing apparatus, between a first recognition model trained with an image without noise and a second recognition model trained with an image with noise according to the amount of noise of an imaged image.

A program according to one aspect of the present technology causes a computer to execute a process of switching between a first recognition model trained with an image without noise and a second recognition model trained with an image with noise according to the amount of noise of an imaged image.

In the information processing apparatus, the information processing method, and the program according to the aspects of the present technology, the first recognition model trained with the image without noise and the second recognition model trained with the image with noise are switched according to the amount of noise of the imaged image.

Note that the information processing apparatus may be an independent apparatus or an internal block constituting one apparatus.

Furthermore, the program can be provided by being transmitted via a transmission medium or by being recorded on a recording medium.

### BRIEF DESCRIPTION OF DRAWINGS

FIG. 1 is a diagram depicting a configuration of an embodiment of a data distribution system to which the present technology is applied.

FIG. 2 is a diagram depicting a configuration example of a sensor device.

FIG. 3 is a diagram depicting a configuration example of a service server.

FIG. 4 is a diagram for explaining generation of a recognition model.

FIG. 5 is a diagram depicting examples of distribution data.

FIG. 6 is a diagram for explaining processing performed by the pre-processing unit.

FIG. 7 is a diagram for explaining an example of an information processing method.

FIG. 8 is a diagram depicting a configuration example of a recognition model switching processing unit.

FIG. 9 is a diagram depicting a configuration example of a noise detector.

FIG. 10 is a flowchart for explaining processing related to recognition model switching.

FIG. 11 is a flowchart for explaining processing related to the recognition model switching.

FIG. 12 is a flowchart for explaining processing related to start of the recognition model switching.

FIG. 13 is a flowchart for explaining another processing related to the start of the recognition model switching.

FIG. 14 is a flowchart for explaining still another processing related to the start of the recognition model switching.

FIG. 15 is a diagram depicting a configuration example of a personal computer.

FIG. 16 is a block diagram depicting an example of schematic configuration of a vehicle control system.

FIG. 17 is a diagram of assistance in explaining an example of installation positions of an outside-vehicle information detecting section and an imaging section.

### MODE FOR CARRYING OUT THE INVENTION

Hereinafter, modes for carrying out the present technology (hereinafter, referred to as embodiments) will be described.

<Schematic Configuration of Data Distribution System>

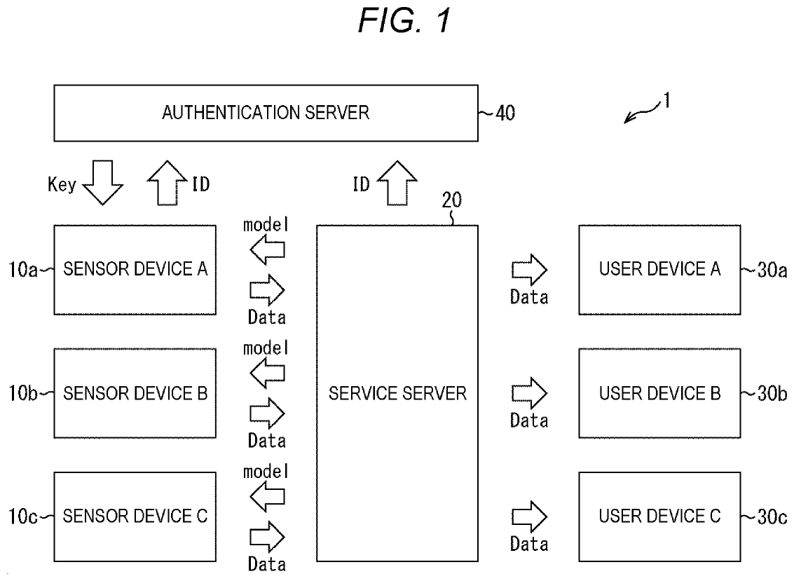

A configuration example of a data distribution system 1 according to an embodiment of the present disclosure will be described with reference to FIG. 1. FIG. 1 is a system diagram depicting a schematic functional configuration of the data distribution system 1 according to the embodiment of the present disclosure. Specifically, as depicted in FIG. 1, the data distribution system 1 according to the present embodiment can mainly include a plurality of sensor devices 10a, 10b, and 10c, a service server 20, a plurality of user devices 30a, 30b, and 30c, and an authentication server 40.

Each of these devices is connected to a network (not illustrated) via a base station (not illustrated) or the like (for example, a base station of a mobile phone, an access point of a wireless local area network (LAN), and the like), for example, thereby constructing the data distribution system 1. Note that, as a communication method used in the network described above, any method can be applied regardless of being wired or wireless (for example, a fifth generation communication system, WiFi (registered trademark), Bluetooth (registered trademark), and the like), and a communication method capable of stably transmitting a large volume of data at a high speed can be used.

Furthermore, the number of sensor devices 10 and the number of user devices (request sources) 30 included in the data distribution system 1 are not limited to three as illustrated in FIG. 1, and three or more sensor devices 10 and three or more user devices 30 may be included in the data distribution system 1 according to the present embodiment. That is, the data distribution system 1 according to the present embodiment can manage the plurality of sensor devices 10, receive requests from the plurality of user devices 30, and transmit data to them. Hereinafter, an outline of each of the devices included in the data distribution system 1 according to the present embodiment will be described.

<Sensor Device>

The sensor device 10 can acquire sensing data (for example, an image, a sound, and the like) of a surrounding installation environment, and transmit distribution data (predetermined data) acquired from the acquired sensing data to an external device such as the user device 30 as described later. Furthermore, the sensor device 10 is desirably equipped with artificial intelligence (AI) functions, and can recognize whether or not the acquired sensing data corresponds to a request (distribution request) from a user on the basis of a recognition model transmitted from the service server 20 as described later. The sensor device 10 functions as an information processing apparatus that handles the sensing data.

For example, the sensor device 10 can be an imaging device (camera) mounted on a mobile body such as an automobile, an imaging device mounted on a smartphone carried by a user, or an imaging device such as a surveillance camera installed in a home, a store, or the like, and in this case, the sensing data is an image. In this case, these imaging devices can acquire an image by collecting light from a subject in the periphery of an installation location, forming a light image on an imaging surface, and converting the light image formed on the imaging surface into an electrical image signal.

Note that the mobile body can be an automobile, an electric vehicle, a hybrid electric vehicle, a motorcycle, a bicycle, a personal mobility, an airplane, a drone, a ship, a robot (mobile robot), a construction machine, an agricultural machine (tractor), or the like in the following description unless otherwise specified.

Furthermore, the sensor device 10 is not limited to the above-described imaging device. For example, the sensor device 10 may be a depth sensor that measures a distance (depth) to a subject, a sound collecting device such as a microphone that collects sound of a surrounding environment, a temperature sensor and a humidity sensor that measure a temperature and a humidity of a surrounding environment, a water level sensor that measures a water level of a river or the like, and the like.

Note that an internal configuration of the sensor device 10 is not basically limited as long as an interface (data transfer format, data transfer method, or the like) common to the data distribution system 1 is provided. Therefore, the data distribution system 1 according to the present embodiment can incorporate various sensor devices 10 having different specifications. Note that a detailed configuration of the sensor device 10 will be described later.

<Service Server>

The service server 20 is a computer that receives a distribution request for requesting distribution of distribution data that can be generated from the sensing data described above from the user device 30 as described later. Furthermore, the service server 20 functions as an information processing apparatus that transmits and receives data to and from the sensor device 10 and the user device 30 and processes the data.

Furthermore, the service server 20 can integrate a plurality of distribution requests (requests), generate a recognition model according to the distribution requests, and transmit the generated recognition model to the above-described sensor device 10. The recognition model is provided for recognition by the sensor device 10, and details thereof will be described later.

Furthermore, the service server 20 can receive distribution data from the sensor device 10 and transmit the received distribution data to the user device 30 corresponding to the distribution request described above as necessary. For example, the service server 20 can be achieved by hardware such as a central processing unit (CPU), a read only memory (ROM), or a random access memory (RAM). Note that a detailed configuration of the service server 20 will be described later.

<User Device>

The user device 30 is a terminal that is carried by a user or installed in the vicinity of the user, and can receive information input from the user, transmit the received information to the service server 20 as a distribution request, and receive distribution data related to the distribution request. For example, the user device 30 can be an information processing apparatus such as a mobile terminal such as a tablet personal computer (PC), a smartphone, a mobile phone, a laptop PC, or a notebook PC, or a wearable device such as a head mounted display (HMD).

More specifically, the user device 30 may include a display section (not illustrated) that performs a display toward a user, an operation section (not illustrated) that receives an operation from the user, a speaker (not illustrated) that outputs a sound toward the user, and the like.

Note that, in the user device 30, for example, an application (app) common to the data distribution system 1 or an application having a specification common to the above-described service server 20 can be installed. When the above-described application is installed, the user device 30 can generate and transmit a distribution request having a format or the like common to the data distribution system 1, and receive distribution data.

A user transmits a distribution request to the service server 20 via the user device 30. The distribution request includes information designating a content (data type) or the like of data whose distribution is requested by the user. For example, the distribution request can include object information constituted by an object (for example, a face, a person, an animal, a mobile body, text, a road (a sidewalk, a crosswalk, a road width, a sign, or the like), a logo, a barcode, or the like) which is a target whose distribution is requested, and information (a data type) designating what kind of information (for example, a quantity, a speed, a position, a state, an age, a sex, a specified name, an estimation result, or the like) about the object is requested.

Furthermore, the distribution request can include data format information designating a data format (for example, an image, text, or the like) of distribution data. Moreover, the distribution request can include identification information (ID) of the user or the user device 30. Note that the distribution request described above may include various types of data used when the service server 20 generates a recognition model (details will be described later).

The distribution request described above has a data format common to the data distribution system 1. For example, the distribution request can include a character string or a numeric string corresponding to object information or data format information. In this case, regarding object information and data format information requested from a user at a high frequency, a corresponding character string or numeric string is defined in advance and stored in a storage unit (not illustrated) held by the service server 20 as a database (not illustrated).

Then, the service server 20 can recognize object information and data format information corresponding to a character string or the like included in a distribution request by referring to the database described above. Furthermore, in a case where a character string or the like corresponding to object information and data format information desired by a user does not exist in the database described above, these object information and data format information may be directly described in the distribution request described above. Alternatively, in this case, a character string corresponding to the object information and the data format information desired by the user may be newly defined, and the defined character string or the like may be described in the distribution request described above and the database described above.

<Authentication Server>

The authentication server 40 is a computer that receives authentication information (ID) from each of the sensor device 10 and the service server 20, and determines whether or not each of these devices has authority to provide or be provided with service of the data distribution system 1 according to the present embodiment. Moreover, the authentication server 40 transmits a key that enables access to the service, a command to provide the service or to be provided with the service, and the like to an authorized device.

Then, the authentication information described above has a data format common to the data distribution system 1. That is, the authentication server 40 is used as an authentication application programming interface (API), and can authenticate the sensor device 10 and the service server 20 and associate the both with each other. The data distribution system 1 according to the present embodiment can ensure security of the data distribution system 1 by incorporating such an authentication server 40, and associate each of the sensor devices 10 with each of the user devices 30 via the service server 20. Furthermore, the authentication server 40 can be achieved by hardware, for example, a CPU, a ROM, a RAM, and the like. Note that the authentication server 40 may perform authentication for the user device 30.

Note that, in the data distribution system 1 according to the present embodiment, each of the sensor device 10 and the service server 20 is not necessarily achieved by a single device, and may be achieved by a plurality of devices that are connected via various wired or wireless networks (not illustrated) and cooperate with each other.

<Detailed Configuration Example of Sensor Device>

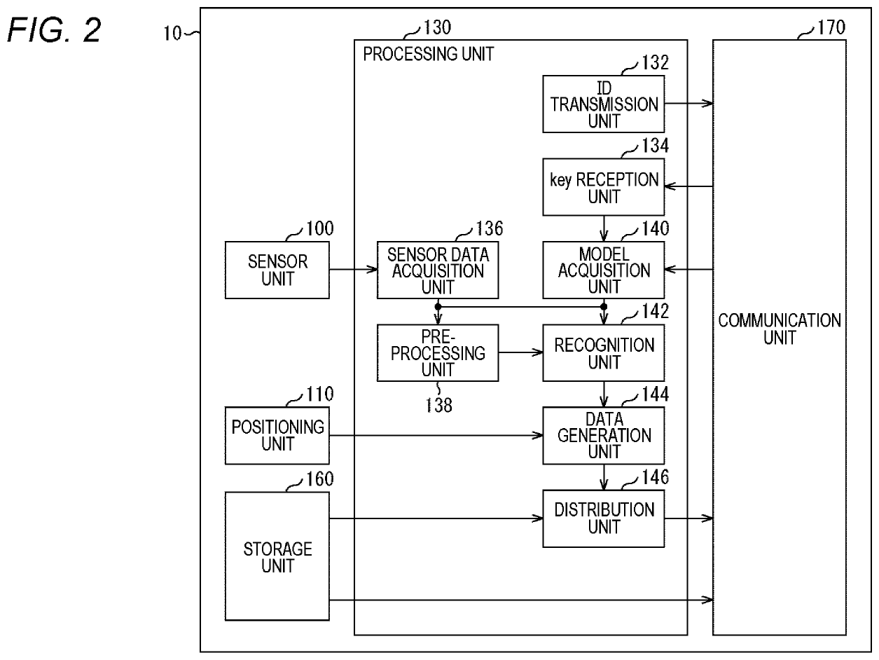

Next, a detailed configuration of the sensor device 10 according to the present embodiment will be described with reference to FIG. 2. FIG. 2 is a block diagram depicting a functional configuration example of the sensor device 10 according to the present embodiment. Specifically, as depicted in FIG. 2, the sensor device 10 mainly includes a sensor unit 100, a positioning unit 110, a processing unit 130, a storage unit 160, and a communication unit 170. Hereinafter, each functional block of the sensor device 10 will be sequentially described.

The sensor unit 100 acquires sensing data and outputs the acquired sensing data to the processing unit 130 as described later. Specifically, in a case where the sensor device 10 is an imaging device, the sensor unit 100 includes imaging optical systems such as an imaging lens and a zoom lens that collect light emitted from a subject, and an imaging element such as a charge coupled device (CCD) or a complementary metal oxide semiconductor (CMOS).

Note that the sensor unit 100 may be provided to be fixed in the sensor device 10, or may be detachably provided in the sensor device 10.

Furthermore, the sensor unit 100 may include a time of flight (TOF) sensor (not illustrated) as a depth sensor in addition to the imaging device. The TOF sensor can acquire a distance between the TOF sensor and a subject and shape information (depth information/image) such as unevenness by directly or indirectly measuring a return time of reflected light from the subject. Moreover, the sensor unit 100 may include a sound collecting device (microphone), a temperature sensor, an atmospheric pressure sensor, a humidity sensor, a wind direction/wind speed sensor, a sunshine sensor, a precipitation sensor, a water level sensor, and the like, and is not particularly limited as long as sensing data can be acquired from a surrounding environment.

The positioning unit 110 acquires positioning data of the sensor device 10 when sensing data corresponding to a distribution request is acquired, and outputs the acquired positioning data to the processing unit 130 (specifically, a data generation unit 144). For example, the positioning data is transmitted to the user device 30 by the distribution unit 146 of the processing unit 130 as described later together with distribution data.

Specifically, the positioning unit 110 can be a global navigation satellite system (GNSS) receiver or the like. In this case, the positioning unit 110 can generate positioning data indicating the latitude and longitude of a current location of the sensor device 10 on the basis of a signal from a GNSS satellite. Furthermore, it is possible to detect a relative positional relationship of a user from, for example, radio frequency identification (RFID), an access point of Wi-Fi, information regarding a wireless base station, and the like, and thus, such a communication apparatus can also be used as the positioning unit 110 described above. Note that the positioning unit 110 is not necessarily provided in the sensor device 10.

The processing unit 130 has a function of processing sensing data acquired by the sensor unit 100 and generating distribution data. The processing unit 130 is achieved by, for example, a processing circuit such as a CPU or a graphics processing unit (GPU), a ROM, a RAM, and the like. Specifically, as depicted in FIG. 2, the processing unit 130 mainly includes an ID transmission unit 132, a key reception unit 134, a sensor data acquisition unit 136, a pre-processing unit 138, a model acquisition unit 140, a recognition unit 142, a data generation unit 144, and a distribution unit 146. Hereinafter, details of each functional unit included in the processing unit 130 will be described.

The ID transmission unit 132 transmits authentication information (ID) of the sensor device 10 to the authentication server 40 via the communication unit 170 as described later. The authentication information is used when the authentication server 40 determines whether or not the sensor device 10 has authority to provide the service of the data distribution system 1 according to the present embodiment. The data distribution system 1 according to the present embodiment ensures the security of the data distribution system 1 by such authentication.

The key reception unit 134 receives a key, which enables access to the service transmitted, from the authentication server 40, a command to provide the service, and the like via the communication unit 170 as described later, and outputs the received key and the like to the model acquisition unit 140 as described later. The model acquisition unit 140 can acquire a recognition model from the service server 20 using the key and the like received by the key reception unit 134.

The sensor data acquisition unit 136 controls the sensor unit 100 to acquire sensing data output from the sensor unit 100, and outputs the acquired sensing data to the pre-processing unit 138 or the recognition unit 142 as described later.

The pre-processing unit 138 pre-processes sensing data output from the sensor data acquisition unit 136 according to information (for example, information regarding teacher data used at the time of generating the recognition model, or the like) included in a recognition model acquired by the model acquisition unit 140 as described later, and outputs the pre-processed sensing data to the recognition unit 142 as described later.

Specifically, the recognition unit 142 recognizes whether or not sensing data corresponds to a distribution request using a recognition model corresponding to the distribution request, the recognition model being obtained by machine learning. Further the sensing data is pre-processed to have form close to the recognition model, so that the sensing data suitable for the recognition described above can be provided to the recognition unit 142. As a result, the recognition accuracy in the recognition unit 142 can be improved according to the present embodiment. Note that details of the pre-processing in the pre-processing unit 138 will be described later.

The model acquisition unit 140 acquires a recognition model corresponding to a distribution request from the service server 20 via the communication unit 170 as described later, and outputs the acquired recognition model to the pre-processing unit 138 and the recognition unit 142. Note that details of the recognition model will be described later.

The recognition unit 142 can recognize whether or not sensing data output from the sensor data acquisition unit 136 or sensing data pre-processed by the pre-processing unit 138 corresponds to a distribution request on the basis of a recognition model output from the model acquisition unit 140 by utilizing the AI function or the like.

More specifically, for example, the recognition unit 142 can recognize whether or not an image of an object designated in a distribution request is included in an image as sensing data (in other words, recognize the object). Then, the recognition unit 142 outputs a result of the recognition to the data generation unit 144 as described later. Note that the recognition model can be obtained by machine learning in the service server 20, and can be, for example, characteristic information that characterizes an object, the characteristic information being obtained from data such as an image or a sound of the object designated by the distribution request. Since the recognition as described above is performed by the sensor device 10, the recognition can be performed immediately after acquisition of the sensing data. Note that details of the recognition in the recognition unit 142 will be described later.

In a case where the above-described recognition unit 142 recognizes that sensing data corresponds to a distribution request, the data generation unit 144 can generate distribution data by performing processing in response to the distribution request on the sensing data. For example, the data generation unit 144 can generate distribution data by extracting only data regarding an object designated by the distribution request from the sensing data, abstracting the data, or converting the data into text data.

More specifically, the distribution data can include at least one information of attribute information, quantity information, position information, state information, operation information, surrounding environment information, and prediction information of the object designated in the distribution request. Moreover, a data format of the distribution data may be image data, sound data, text data, or the like, and is not particularly limited. In this manner, the sensor device 10 processes the sensing data corresponding to the distribution request and generates the distribution data, so that the distribution can be implemented in real time.

Furthermore, in a case where sensing data does not correspond to a distribution request, the data generation unit 144 does not generate and distribute distribution data. Therefore, according to the present embodiment, a load of data transmission can be reduced as compared with a case where sensing data is transmitted regardless of whether or not the sensing data corresponds to a distribution request.

Moreover, for example, the data generation unit 144 can exclude information (for example, imaging of a person to the extent that the person can be specified) regarding privacy included in sensing data from distribution data. Furthermore, the data generation unit 144 can mask the information regarding the privacy on the distribution data, for example. Accordingly, protection of the privacy is ensured. Note that an example of such processing will be described later.

The distribution unit 146 distributes distribution data generated by the above-described data generation unit 144 to the user device 30 or the service server 20. Note that the distribution unit 146 can also distribute a plurality of different pieces of distribution data to the user device 30 or the service server 20. For example, the distribution unit 146 outputs, as the information described above, information on a date and time when sensing data corresponding to distribution data has been acquired, information on a date and time when the distribution data has been distributed, a data type, a data format, a distribution amount, a distribution destination (for example, recognition information of the user device 30), and the like.

The storage unit 160 stores programs, information, and the like configured for the processing unit 130 to execute various processes, and information obtained by the processes. The storage unit 160 is achieved by, for example, a storage device such as a hard disk drive (HDD).

The communication unit 170 can transmit and receive information to and from an external device such as the service server 20. The communication unit 170 can be said to be a communication interface having a function of transmitting and receiving data. Note that the communication unit 170 is achieved by a communication device (not illustrated) such as a communication antenna, a transmission/reception circuit, or a port.

<Detailed Configuration of Service Server>

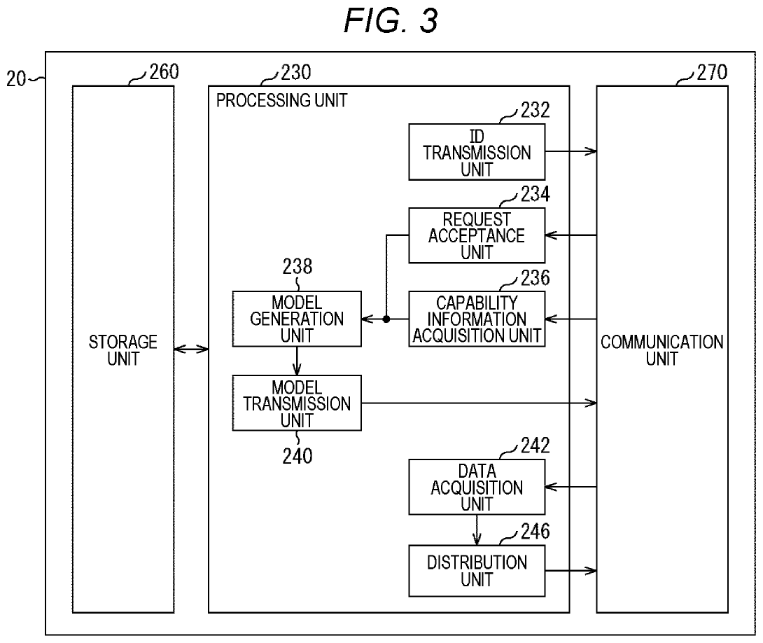

Next, a detailed configuration of the service server 20 according to the present embodiment will be described with reference to FIG. 3. FIG. 3 is a block diagram depicting a functional configuration example of the service server 20 according to the present embodiment. Specifically, as depicted in FIG. 3, the service server 20 mainly includes a processing unit 230, a storage unit 260, and a communication unit 270. Hereinafter, each functional block of the service server 20 will be sequentially described.

The processing unit 230 has a function of acquiring a distribution request from the user device 30 via the communication unit 270 as described later, generating a recognition model in response to the acquired distribution request, and transmitting the generated recognition model to the sensor device 10. The processing unit 230 is achieved by, for example, a processing circuit such as a CPU or a GPU, a ROM, a RAM, and the like. Specifically, as depicted in FIG. 3, the processing unit 230 mainly includes an ID transmission unit 232, a request acceptance unit 234, a capability information acquisition unit 236, a model generation unit 238, a model transmission unit 240, a data acquisition unit 242, and a distribution unit 246. Hereinafter, details of each functional unit included in the processing unit 230 will be described.

The ID transmission unit 232 transmits authentication information (ID) of the service server 20 to the authentication server 40 via the communication unit 270 as described later. The authentication information is used when the authentication server 40 determines whether or not the service server 20 has authority to be provided with the service of the data distribution system 1 according to the present embodiment. The data distribution system 1 according to the present embodiment ensures the security of the data distribution system 1 by such authentication.

The request acceptance unit 234 receives a distribution request from one or a plurality of the user devices 30 via the communication unit 270 as described later, and outputs the received distribution request to the model generation unit 238 as described later. Note that the request acceptance unit 234 may integrate common distribution requests and output the integrated distribution request.

The capability information acquisition unit 236 acquires in advance capability information indicating a sensing capability (type, accuracy, position, range, granularity, and the like of sensing) and a calculation capability of each of the sensor devices 10 via the communication unit 270 as described later, and outputs the acquired capability information to the model generation unit 238 as described later. Note that it is preferable that the capability information acquisition unit 236 acquires the capability information again when the function of the sensor device 10 or the like is updated.

Then, in the model generation unit 238 as described later, a recognition model corresponding to a capability of each of the sensor devices 10 is generated on the basis of the capability information of each of the sensor devices 10. Therefore, since the capability information is acquired again when the function of the sensor device 10 or the like is updated according to the present embodiment, the recognition model can be updated to be suitable for the capability of each of the sensor devices 10 at a current time point.

The model generation unit 238 can generate a recognition model corresponding to a distribution request by machine learning in accordance with the capability of each of the sensor devices 10 on the basis of the distribution request from the request acceptance unit 234 and capability information from the capability information acquisition unit 236. Moreover, the model generation unit 238 can output the generated recognition model to the model transmission unit 240 as described later.

Note that the model generation unit 238 may acquire data necessary for the machine learning from the user device 30 or another server (not illustrated). Since the model generation unit 238 can generate the recognition model suitable for each of the sensor devices 10, the recognition in the sensor device 10 can be achieved. Furthermore, since it is also possible to acquire the capability information again and to generate the recognition model again when the function of the sensor device 10 or the like is updated, it is possible to improve the recognition in the sensor device 10 by dynamically changing the recognition model.

Furthermore, the model generation unit 238 may cause a recognition model to include information (for example, information regarding teacher data used at the time of generating the recognition model or the like) regarding data used in the machine learning of the model generation unit 238. The information is used when the pre-processing unit 138 of the sensor device 10 performs pre-processing such that sensing data has a form close to the recognition model. Moreover, the model generation unit 238 cause a recognition model to include setting information regarding a setting of the sensor unit 100 of the sensor device 10 in order to acquire sensing data required to generate distribution data specified by a distribution request on the basis of capability information of the sensor device 10 Note that the model generation unit 238 may be provided as a device separate from the service server 20, and is not particularly limited.

The model transmission unit 240 transmits recognition models acquired from the above-described model generation unit 238 to the sensor devices 10 respectively corresponding to the recognition models via the communication unit 270.

The data acquisition unit 242 acquires distribution data corresponding to a distribution request from the sensor device 10 via the communication unit 270 as described later, and outputs the acquired distribution data to the distribution unit 246 as described later. Note that the data acquisition unit 242 is not necessarily provided in a case where the distribution data is directly transmitted from the sensor device 10 to the user device 30.

The distribution unit 246 distributes distribution data acquired by the above-described data acquisition unit 242 to the user device 30 corresponding to a distribution request via the communication unit 270 as described later. Note that the distribution unit 246 is not necessarily provided in a case where the distribution data is directly transmitted from the sensor device 10 to the user device 30.

The storage unit 260 stores programs, information, and the like configured for the processing unit 230 to execute various processes, and information obtained by the processes. Note that the storage unit 260 is achieved by a storage device, for example, an HDD and the like.

The communication unit 270 can transmit and receive information to and from an external device such as the sensor device 10 or the user device 30. In other words, the communication unit 270 can be said to be a communication interface having a function of transmitting and receiving data. Note that the communication unit 270 is achieved by a communication device (not illustrated) such as a communication antenna, a transmission/reception circuit, or a port.

<Regarding Recognition According to Present Embodiment>

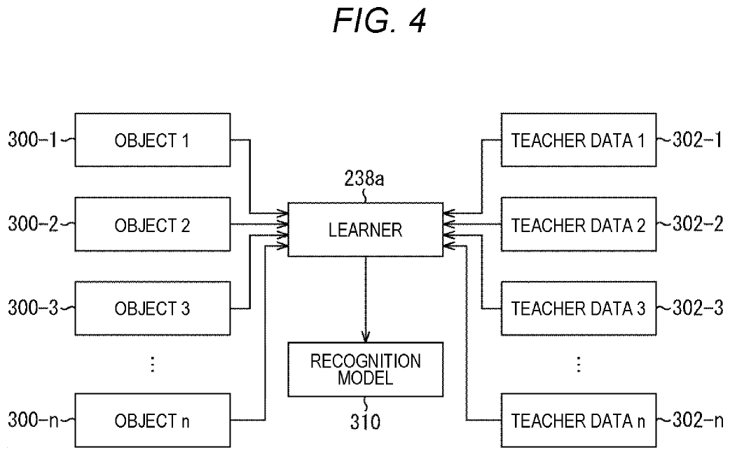

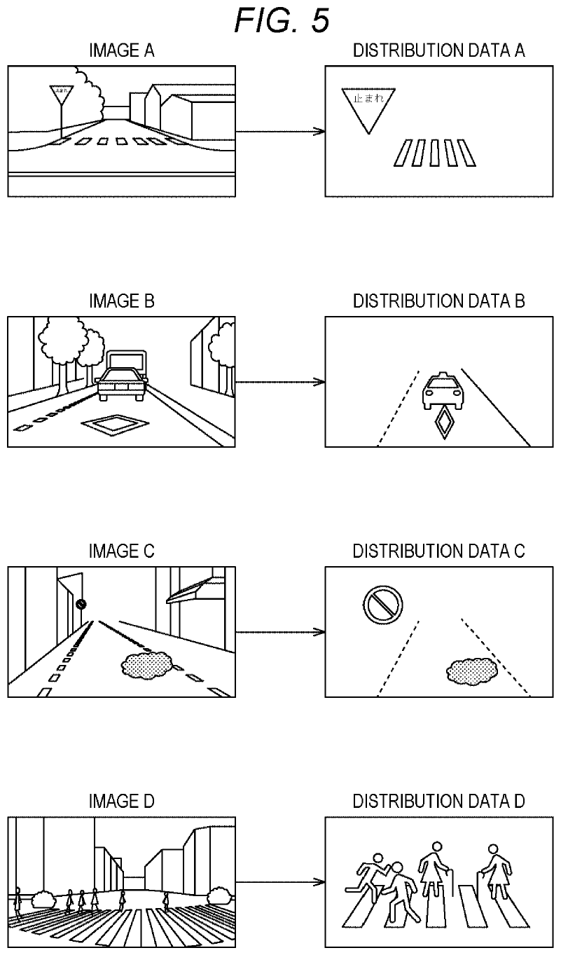

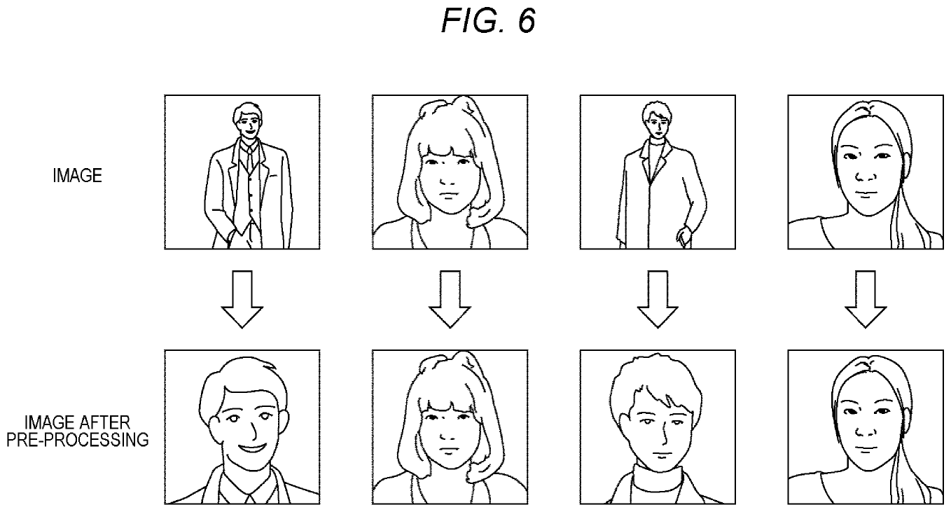

Next, an example of recognition according to the present embodiment will be described with reference to FIGS. 4 to 6. FIG. 4 is an explanatory diagram for describing an example of generation of a recognition model 310 according to the present embodiment; FIG. 5 is an explanatory diagram for describing examples of distribution data according to the present embodiment; and FIG. 6 is an explanatory diagram for describing examples of pre-processing according to the present embodiment.

Generation of a model used in the recognition according to the present embodiment will be described. As described above, a recognition model is generated by the model generation unit 238 of the service server 20. As depicted in FIG. 4, the model generation unit 238 described above includes, for example, a supervised learner 238a such as a support vector regression or a deep neural network.

For example, a plurality of pieces of teacher data 302-1 to 302-n, which are pieces of information regarding objects each of which is designated by a distribution request and is a target whose distribution is requested, is input to the learner 238a. Then, the learner 238a can generate the recognition model 310 used for the recognition by the recognition unit 142 of the sensor device 10 by performing machine learning on the plurality of pieces of input teacher data 302-1 to 302-n.

Since the plurality of sensor devices 10 has mutually different sensing capabilities and calculation capabilities, that is, have mutually different recognizable capabilities, it is preferable that the learner 238a generate each of the recognition models 310 according to capability information of each of the above-described sensor devices 10. Therefore, even if the plurality of sensor devices 10 having various specifications is included, the recognition model 310 according to the capability of each of the sensor devices 10 can be generated, and thus, the recognition can be performed by each of the sensor devices 10.

More specifically, for example, the learner 238a described above receives the inputs of the teacher data 302-1 to 302-n, which are respectively labeled with objects 300-1 to 300-n each of which is designated by a distribution request and is a target whose distribution is requested, regarding the objects. Then, the learner 238a extracts characteristic points and characteristic amounts of the objects from the plurality of pieces of teacher data 302-1 to 302-n by machine learning using a convolutional neural network or the like. Information such as the characteristic point extracted in this manner is the recognition model 310 for recognizing whether or not information of the object is included in sensing data acquired by each of the sensor devices 10.

Here, the generation of the recognition model 310 according to the present embodiment will be described with a specific example. For example, a description will be given regarding a case where it has been requested to search for a predetermined person (object) using an image (sensing data) acquired by the sensor device 10 through a distribution request from a user (a case where distribution data is position information of the predetermined person).

The service server 20 acquires a plurality of images of the predetermined person from the user device 30 that has transmitted the distribution request described above or a server (not illustrated) as a plurality of pieces of teacher data 302 used at the time of generating the recognition model 310. Then, as depicted in FIG. 4, the service server 20 inputs the plurality of acquired images (teacher data) 302-1 to 302-n to the learner 238a with labels of predetermined persons (objects) 300-1 to 300-n attached thereto. Moreover, the learner 238a extracts characteristic points and characteristic amounts of images of the predetermined person (object) 300 from the plurality of images (teacher data) 302-1 to 302-n by machine learning using the plurality of images (teacher data) 302-1 to 302-n, and generates the recognition model 310 for recognizing an image of the predetermined person (object) 300 from the image (sensing data).

Note that, similarly to the above example, in a case where it has been requested to search for a predetermined person (object) using sensing data (here, a type of sensing data is not particularly limited) acquired by the sensor device 10 through the distribution request from a user, the learner 238a may generate the recognition model 310 in accordance with the type of sensing data that can be acquired by each of the sensor devices 10.

More specifically, the learner 238a generates the recognition model 310 for recognizing an image of the predetermined person from an image for the sensor device 10 capable of acquiring the image, and generates the recognition model 310 for recognizing a sound of the predetermined person from an environmental sound is generated for the sensor device 10 capable of acquiring the environmental sound. Therefore, even if the plurality of sensor devices 10 having various specifications is included, the recognition model 310 according to the capability of each of the sensor devices 10 can be generated, and thus, the recognition can be performed by each of the sensor devices 10.

Furthermore, as described above, the recognition model 310 may include information regarding the teacher data 302 used in the machine learning. Here, the information regarding the teacher data 302 can be a type (for example, an image, a sound, or the like) of the teacher data 302 and quality (a distortion compensation level, a pixel defect, white balance, an image size, chroma, brightness, gamma, contrast, an edge enhancement level, focus, an exposure level, resolution, a dynamic range, a noise reduction level, or the like) of the teacher data.

Such information regarding the teacher data 302 can be used when the pre-processing unit 138 of the sensor device 10 described above performs pre-processing such that the acquired sensing data has a form close to the recognition model (specifically, the teacher data 302). Accordingly, the recognition accuracy in the recognition unit 142 of the sensor device 10 can be improved.

Furthermore, as described above, the recognition model 310 may include setting information regarding a setting of the sensor unit 100 of the sensor device 10 in order to acquire sensing data required to generate distribution data specified by a distribution request. Here, the setting information can be a type (for example, an image, a sound, or the like) of sensing data and a setting value (a distortion compensation level, white balance, an image size, chroma, brightness, gamma, contrast, an edge enhancement level, focus, an exposure level, resolution, a dynamic range, a noise reduction level, or the like) of the sensor unit 100 in accordance with desired quality of sensing data. Such setting information is used at the time of setting the sensor unit 100, and makes it possible to acquire sensing data suitable for the recognition model 310, and eventually, the recognition accuracy in the recognition unit 142 can be improved.

Note that the learner 238a may be provided in a server separate from the service server 20, and is not particularly limited. Moreover, a learning method in the learner 238a is not limited to the above-described method, and another method may be used.

<Recognition Using Recognition Model>

Next, recognition using the above-described recognition model 310 will be described. As described above, the recognition model 310 is used when the recognition unit 142 of the sensor device 10 recognizes whether or not sensing data or pre-processed sensing data corresponds to a distribution request. Here, the recognition according to the present embodiment will be described with a specific example.

For example, a description will be given regarding a case where it has been requested to search for a predetermined person (object) using an image (sensing data) acquired by the sensor device 10 through a distribution request from a user (distribution data is position information of the predetermined person). The sensor device 10 acquires the image from the sensor unit 100. Then, the recognition unit 142 refers to the recognition model 310 acquired from the service server 20, specifically, a characteristic point and a characteristic amount of an image of the predetermined person (object) 300, and recognizes whether or not the image of the predetermined person is included in the image acquired from the sensor unit 100. That is, since the recognition as described above is performed by the sensor device 10, the recognition can be performed immediately after acquisition of the image.

As described above, since the plurality of sensor devices 10 has mutually different sensing capabilities and calculation capabilities, that is, have mutually different recognizable capabilities, each of the recognition models 310 is generated according to capability information of each of the sensor devices 10, and each recognition is performed. For example, in a case where it has been requested to search for a predetermined person (object) using sensing data (here, a type of the sensing data is not particularly limited) acquired by the sensor device 10 through a distribution request from a user, in the present embodiment, the recognition unit 142 of the sensor device 10 capable of acquiring an image recognizes an image of the predetermined person from the image on the basis of the recognition model 310, and the recognition unit 142 of the sensor device 10 capable of acquiring an environmental sound recognizes a sound of the predetermined person from the environmental sound on the basis of the recognition model 310.

Note that the recognition unit 142 may be provided in a device separate from the sensor device 10, and is not particularly limited. Moreover, a recognition method in the recognition unit 142 is not limited to the above-described method, and another method may be used.

Next, examples of distribution data according to the present embodiment will be described with reference to FIG. 5. As described above, the data generation unit 144 of the sensor device 10 performs processing suitable for a corresponding distribution request on sensing data to generate distribution data. The distribution data can include at least one information of attribute information, quantity information, position information, state information, operation information, surrounding environment information, and prediction information of the object designated in the distribution request.

Furthermore, the distribution data can have a data format such as an image or text, and is not particularly limited. Moreover, the distribution data preferably includes identification information of a user who has transmitted the distribution request or the user device 30. That is, for example, the data generation unit 144 can extract only data regarding an object designated by the distribution request from the sensing data as the distribution data, abstract the data, or convert the data into text data in response to the distribution request.

In this manner, the distribution in real time can be implemented in which the data generation unit 144 processes the sensing data corresponding to the distribution request to generate the distribution data. Furthermore, in a case where sensing data does not correspond to a distribution request, the data generation unit 144 does not generate and transmit distribution data. Therefore, according to the present embodiment, a load of data transmission can be reduced as compared with a case where sensing data is transmitted regardless of whether or not the sensing data corresponds to a distribution request.

Furthermore, the data generation unit 144 can exclude information (for example, imaging of a person to the extent that the person can be specified) regarding the privacy included in the sensing data from the distribution data. Accordingly, the protection of the privacy is ensured. More specifically, in the uppermost example of FIG. 5, in a case where an image A of a road is acquired as sensing data corresponding to a distribution request, the data generation unit 144 extracts only a signboard sign or a crosswalk designated by the distribution request to generate distribution data A.

Furthermore, in the second example from the top of FIG. 5, in a case where an image B of a road is acquired as sensing data corresponding to a distribution request, the data generation unit 144 extracts only a sign or a vehicle, designated by the distribution request, on the road to generate distribution data B.

Furthermore, in the third example from the top of FIG. 5, in a case where an image C of a road is acquired as sensing data corresponding to a distribution request, the data generation unit 144 extracts only a sign or a puddle designated by the distribution request to generate distribution data C.

Moreover, in the lowermost example of FIG. 5, in a case where an image D of a road is acquired as sensing data corresponding to a distribution request, the data generation unit 144 extracts only a crosswalk designated by the distribution request or a person crossing the crosswalk to generate distribution data D.

Next, examples of pre-processing according to the present embodiment will be described with reference to FIG. 6. As described above, the recognition unit 142 can recognize whether or not sensing data corresponds to a distribution request using the recognition model 310 obtained by machine learning. Then, the pre-processing unit 138 of the sensor device 10 performs pre-processing such that the sensing data has a form close to the recognition model 310 on the basis of information regarding the above-described teacher data in order to improve the recognition accuracy in the recognition unit 142. Specifically, the pre-processing unit 138 performs the pre-processing on the sensing data such that a format, a distortion compensation level, a pixel defect, white balance, an image size, chroma, brightness, gamma, contrast, an edge enhancement level, focus, an exposure level, resolution, a dynamic range, a noise reduction level, or the like is equivalent to that of the teacher data 302.

More specifically, for example, in a case where each of images as depicted in the upper part of FIG. 6 is acquired as sensing data by the sensor unit 100 of the sensor device 10, the pre-processing unit 138 performs pre-processing on each of the image sin the upper part of FIG. 6 such that an image quality size and focus are equivalent to those of the teacher data 302. Then, the pre-processing unit 138 acquires each of images as depicted in the lower part of FIG. 6. In this manner, the pre-processing unit 138 performs the pre-processing so as to obtain the sensing data having a data level equivalent to that of the teacher data 302 used at the time of generating the recognition model 310 according to the present embodiment, whereby the recognition accuracy in the recognition unit 142 can be further improved.

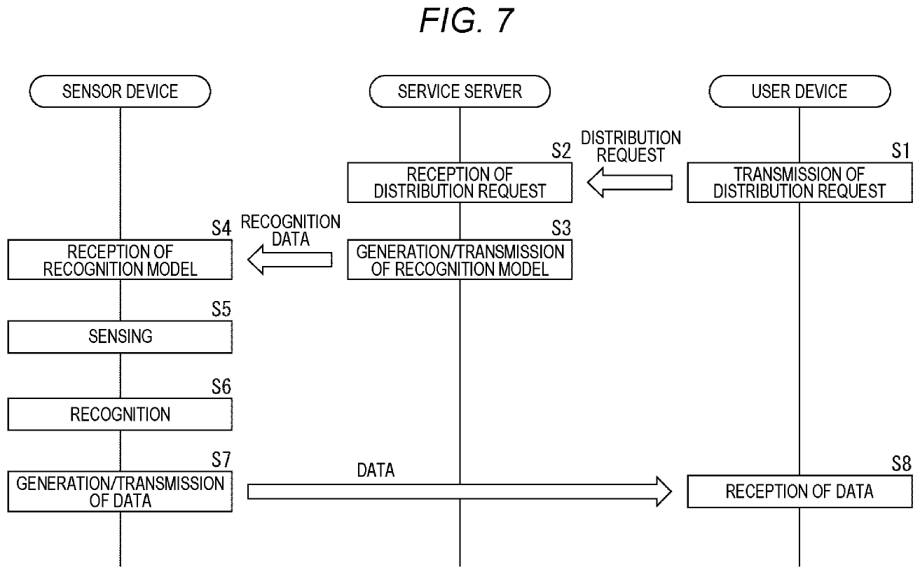

Next, an information processing method according to the embodiment of the present disclosure will be described with reference to FIG. 7. FIG. 7 is a sequence diagram depicting an example of the information processing method according to the present embodiment.

In step S1, the user device 30 receives information input from a user, and transmits the received information to the service server 20 as a distribution request. In step S2, the service server 20 receives the distribution request from the user device 30.

In step S3, the service server 20 generates a recognition model on the basis of the distribution request received in the above-described step S2, and transmits the generated recognition model to each of the sensor devices 10.

In step S4, the sensor device 10 receives the recognition model from the service server 20. Furthermore, in step S5, the sensor device 10 performs sensing to acquire sensing data. Moreover, in step S6, the sensor device 10 recognizes whether or not the sensing data acquired in the above-described step S5 corresponds to the distribution request on the basis of the recognition model received in the above-described step S4.

The sensor device 10 performs processing corresponding to the distribution request on the sensing data on the basis of recognition that the sensing data corresponds to the distribution request in the above-described step S6 to generate distribution data. Moreover, in step S7, the sensor device 10 directly transmits the generated distribution data to the user device 30 related to the distribution request.

Note that, instead of being directly transmitted, distribution data may be transmitted from the sensor device 10 to the user device 30 via the service server 20 as another embodiment.

In step S8, the user device 30 receives the distribution data transmitted from the sensor device 10.

As described above, it is possible to construct a framework in which various users can easily use information obtained from pieces of sensing data acquired by various sensor devices 10 according to the above-described present embodiment.

<Addition of Recognition Model Switching Function>

As described above, the sensor device 10 is an imaging device (camera) mounted on a mobile body such as an automobile, an imaging device mounted on a smartphone carried by a user, or an imaging device such as a surveillance camera installed in a home, a store, or the like.

Noise is sometimes added to an image imaged by the sensor device 10. When the noise increases, accuracy of recognition by a recognition model is likely to decrease. As described with reference to FIG. 4, the recognition model is, for example, a model learned by the supervised learner 238a such as a support vector regression or a deep neural network.

For example, in a case where the learner 238a performs learning by applying a deep neural network technology, the learning is often performed with an image without noise. A recognition model trained with an image without noise has a high accuracy at the time of processing an image without noise, but may have a low accuracy at the time of processing an image with noise.

In a case of processing an image containing noise, use of a recognition model optimized for the image containing noise leads to a higher detection accuracy and a higher recognition accuracy than use of a recognition model trained with an image containing no noise.

In consideration of such a fact, a recognition model trained with an image containing noise is used in a case where an image imaged by the sensor device 10 contains noise, and a recognition model trained with an image without noise is used in a case of not containing noise. Hereinafter, the recognition model trained with the image containing noise is described as a noise recognition model, and the recognition model trained with the image without noise is described as a normal recognition model.

In a case of being generated as described with reference to FIG. 4, the noise recognition model can be generated by preparing a plurality of noise-containing images (a data set of the noise-containing images) and performing learning. Furthermore, it is also possible to generate an image obtained by artificially adding noise to an image without noise, and perform learning using the image containing the noise.

When the noise recognition model and the normal recognition model are generated in this manner, the noise recognition model tends to have a deeper layer (larger scale) than the normal recognition model. In this manner, a difference between the recognition models is a difference in the layer depth, and processing can be performed with a high performance according to a recognition model subjected to learning suitable for a processing target.

In the following description, the description will be continued by exemplifying a case in which processing is performed using the normal recognition model and processing is performed by switching to the noise recognition model in a case where it is determined that the amount of noise on an image imaged by the sensor device 10 has increased.

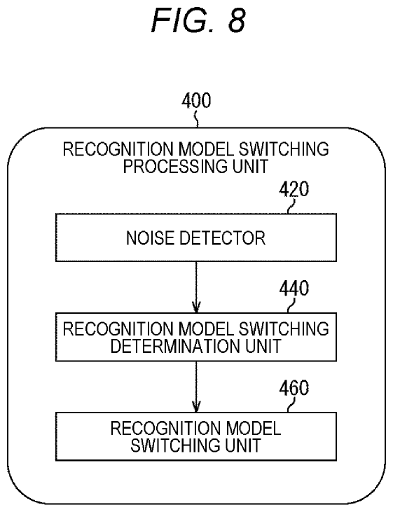

FIG. 8 is a diagram depicting a functional configuration example of a system including the sensor device 10 and the service server 20 in a case where a recognition model is switched according to the amount of noise. The system including the sensor device 10 and the service server 20 includes a recognition model switching processing unit 400 that executes processing related to the recognition model switching.

The recognition model switching processing unit 400 includes a noise detector 420, a recognition model switching determination unit 440, and a recognition model switching unit 460. The noise detector 420 detects the amount of noise on an image imaged by the sensor unit 100 of the sensor device 10.

The recognition model switching determination unit 440 determines whether or not to switch a recognition model on the basis of the amount of noise detected by the noise detector 420. For example, when it is determined that the amount of noise detected by the noise detector 420 is a predetermined threshold or more, the recognition model switching determination unit 440 determines to switch the recognition model to the noise recognition model.

When the recognition model switching determination unit 440 determines to switch the recognition model, the recognition model switching unit 460 executes the processing related to the recognition model switching. In the embodiment described above, a recognition model is transmitted from the service server 20 side to the sensor device 10 side, and the sensor device 10 performs processing using the transmitted recognition model. In such a case, the recognition model switching unit 460 causes the service server 20 to transmit the noise recognition model to the sensor device 10, and performs a process of instructing the sensor device 10 to start processing with the noise recognition model.

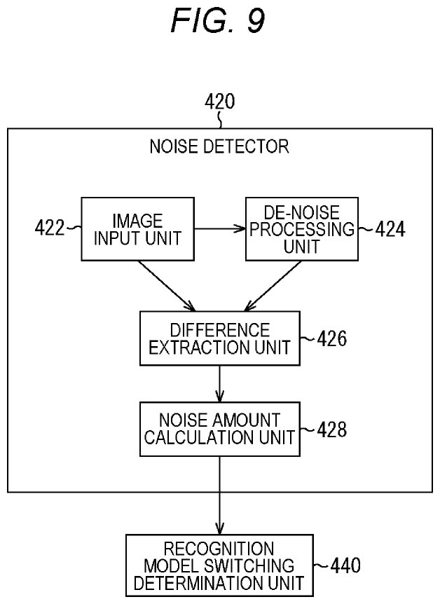

FIG. 9 is a diagram depicting a configuration example of the noise detector 420. The noise detector 420 includes an image input unit 422, a de-noise processing unit 424, a difference extraction unit 426, and a noise amount calculation unit 428.

The image input unit 422 receives an input of an image imaged by the sensor unit 100 of the sensor device 10. The image input to the image input unit 422 is supplied to the de-noise processing unit 424 and the difference extraction unit 426.

The de-noise processing unit 424 executes processing to remove noise from the input image, for example, noise reduction (NR) processing, generates an image in which noise on the image has been reduced, and supplies the generated image to the difference extraction unit 426.

The difference extraction unit 426 acquires the image input by the image input unit 422, that is, the image imaged by the sensor unit 100 in this case, and the image in which the noise has been reduced by the de-noise processing unit 424, and extracts a difference between the two images. That is, the difference between the image imaged by the sensor unit 100 and the image in which a noise component of the image has been reduced is calculated.

In a case where there are few noise components of the image imaged by the sensor unit 100, the difference from the image with the reduced noise component is small. Furthermore, in a case where there are many noise components of the image imaged by the sensor unit 100, the difference from the image with the reduced noise component is large. The difference extraction unit 426 performs a process of extracting a noise component.

The noise amount calculation unit 428 calculates the amount of noise using the difference, that is, the noise component, extracted by the difference extraction unit 426. For example, the noise amount calculation unit 428 is obtained by the following Formula (1).

Noise amountn=Σabs(sub) (1)

Formula (1) is a formula for cumulatively adding absolute values of differences calculated by the difference extraction unit 426. For example, the difference extraction unit 426 calculates a difference for each pixel, and the noise amount calculation unit 428 cumulatively adds the difference calculated for each pixel to calculate a difference value in one image, that is, the amount of noise.

The amount of noise calculated by the noise amount calculation unit 428 is supplied to the recognition model switching determination unit 440. The recognition model switching determination unit 440 determines whether or not the amount of noise calculated by the noise amount calculation unit 428 is at a level at which a recognition model is switched. The recognition model switching determination unit 440 determines whether or not it is the level at which the recognition model is switched by determining whether or not the following is established.

noise amount n>threshold This threshold is a value set as the amount of noise for determining to switch the recognition model.

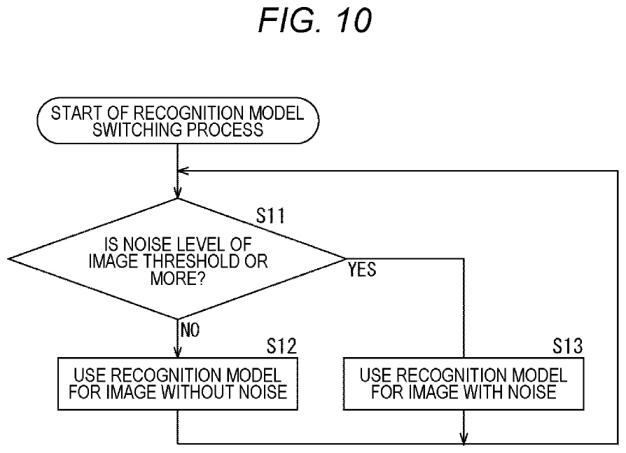

Processing of the recognition model switching processing unit 400 will be described with reference to a flowchart of FIG. 10. In step S11, it is determined whether or not a noise level of an image is a threshold or higher. The process in step S11 is performed in such a manner that the amount of noise is calculated by the noise detector 420 and the recognition model switching determination unit 440 determines whether or not the calculated noise amount is at a level at which the recognition model is switched.

In a case where it is determined in step S11 that the noise level of the image is not the threshold or higher, the processing proceeds to step S12. In step S12, a mode (hereinafter, described as a normal mode as appropriate) in which recognition processing using the recognition model for the image without noise (normal recognition model) is performed is set.

On the other hand, in a case where it is determined in step S11 that the noise level of the image is the threshold or higher, the processing proceeds to step S13. In step S13, a mode (hereinafter, described as a noise-handling mode as appropriate) in which recognition processing using the recognition model for the image with noise (noise recognition model) is performed is set.

In this manner, the recognition model to be used is set according to the noise level.

<Processing Related to Recognition Model Switching>

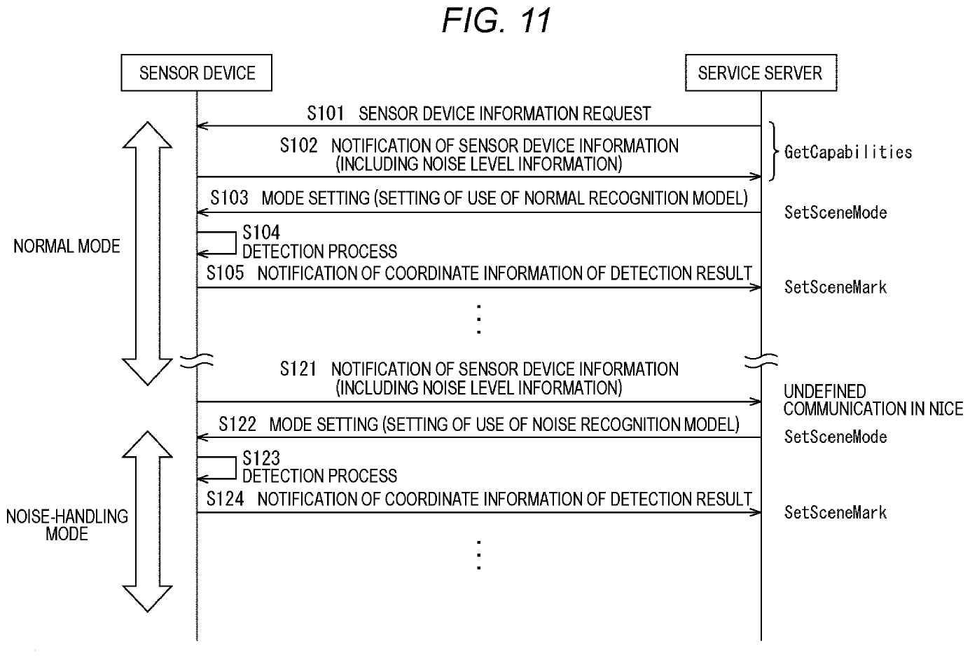

Processing performed between the sensor device 10 and the service server 20 will be described with reference to a flowchart of FIG. 11. In FIG. 11, an application programming interface (API) used when the specifications defined by the network of intelligent camera ecosystem (NICE) Alliance are applied is described on the right side of the drawing. This is a description indicating that the present technology can execute processing on the basis of the NICE standard, but is not a description indicating that an application range of the present technology is limited only to the NICE standard. That is, the present technology can be applied to the NICE standard, and can also be applied to standards other than the NICE standard.

In step S101, the service server 20 issues an information request to the sensor device 10. In response to this request, the sensor device 10 notifies the service server 20 of information regarding the sensor device 10 in step S102. In a case where transmission and reception of the information regarding the sensor device 10 executed in these steps S101 and S102 are performed on the basis of the NICE standard, an API called GetCapabilities is used.

The API called GetCapabilities is an API for inquiring capability of a device, and is, for example, an API for transmitting and receiving information such as whether there is a capability of capturing a moving image or a still image, whether JPEG, H.264, or the like can be handled as a format, or any corresponding SceneMode.

In a case where the present technology is applied, information of the sensor device 10 transmitted and received using an API called GetCapabilities also includes information regarding a noise amount (noise level) detected by the noise detector 420.

In step S103, the service server 20 sets a mode. The service server 20 receives information regarding a capability and a state of the sensor device 10 from the sensor device 10, and sets an appropriate mode on the basis of the information. The mode to be set is the normal mode or the noise-handling mode.

Furthermore, setting the mode also includes setting a recognition model used by the recognition unit 142 (FIG. 8). In other words, an AI function corresponding to the set mode is set. The mode set in step S103 is the normal mode, and the set recognition model is the normal recognition model.

As described above, the recognition unit 142 recognizes whether or not sensing data output from the sensor data acquisition unit 136 or sensing data pre-processed by the pre-processing unit 138 corresponds to a distribution request, for example, a request for recognition of a specific person, on the basis of a recognition model output from the model acquisition unit 140 by utilizing the AI function. The recognition model used for such recognition using the AI function is set in step S103.

In a case where the processing related to the mode setting executed in step S103 is performed on the basis of the NICE standard, an API called SetSceneMode is used. The API called SetSceneMode is an API for setting SceneMode, and SceneMode is person detection, moving object detection, or the like.

In step S104, the sensor device 10 performs a detection process using the set recognition model. For example, a process of detecting a person or a process of recognizing a person are executed using an image acquired by the sensor unit 100.

In step S105, the sensor device 10 transmits information detected in the detection process to the service server 20. The transmitted information is, for example, information regarding coordinates of the detected person.

In a case where the notification of the detection result executed in step S105 is performed on the basis of the NICE standard, an API called SetSceneMark is used. This API called SetSceneMark is an API for transmitting information applied to a trigger set in SetSceneMode when the trigger is applied. For example, in a case where person detection is set in SetSceneMode, meta information, such as a thumbnail and a time stamp when a person has been detected, is transmitted.

The detection process in step S104 and the notification process of the detection result in step S105 are repeatedly performed. While the detection process and the notification process are being repeatedly performed, the recognition model switching process described with reference to FIG. 10 is also performed. In a case where it is determined in step S11 of the flowchart described with reference to FIG. 10 that the noise level of the image imaged by the sensor device 10 is the threshold or higher, processing to transition from the normal mode to the noise-handling mode (processing related to the recognition model switching) is started.

When such mode transition processing is started, information of the sensor device 10 is notified in step S121 of the flowchart depicted in FIG. 11. Note that there is a plurality of embodiments depending on whether the mode transition process is started by an instruction from the sensor device 10 side or an instruction from the service server 20 side, and the like, and thus, details will be described later.

In step S121, the start of the mode transition, in other words, the start of a change of the recognition model is performed by transmitting noise level information from the sensor device 10 to the service server 20.

An API for transmitting the information regarding the sensor device 10 from the sensor device 10 to the service server 20 in order to start such a mode transition (start the change of the recognition model) is undefined communication in the NICE standard. When the API for performing such communication is newly defined in the NICE standard, it is possible to handle the communication related to the start of the mode transition in the NICE standard as well.

In step S122, the service server 20 sets a mode on the sensor device 10. The mode setting process in step S122 is basically performed similarly to the mode setting process in step S103. When receiving information regarding the amount of noise of the sensor device 10 from the sensor device 10, the service server 20 sets a mode suitable for the amount of noise. In the example depicted in FIG. 11, the noise-handling mode is set in step S122. In a case where the processing related to the mode setting in step S122 is performed on the basis of the NICE standard, an API called SetSceneMode can be used.

In step S122, when being switched to the noise-handling mode, the service server 20 transmits the noise recognition model to the sensor device 10, and the sensor device 10 acquires the noise recognition model by the model acquisition unit 140 (FIG. 2) and sets the noise recognition model as the recognition model used by the recognition unit 142. Since the recognition model is set in this manner, the sensor device 10 starts processing with the noise recognition model.

In step S123, the sensor device 10 performs a detection process using the set noise recognition model. In this detection process, for example, a process of detecting a person or a process of recognizing a person are executed using an image acquired by the sensor unit 100 similarly to step S104.

In step S124, the sensor device 10 transmits information detected in the detection process to the service server 20. The transmitted information is, for example, information regarding coordinates of the detected person.

Note that the description has been given here by exemplifying the case where the normal recognition model is switched to the noise recognition model, but the recognition model is returned to the normal recognition model in a case where the amount of noise decreases to be the threshold or less while the processing with the noise recognition model is being performed. That is, in the present embodiment, the noise recognition model is used when the amount of noise has increased, and the normal recognition model is used when the amount of noise is small. Accordingly, it is possible to perform processing using an optimum recognition model according to the amount of noise, and it is possible to prevent a decrease in accuracy of the processing using the recognition model.

<First Processing Related to Recognition Model Switching>

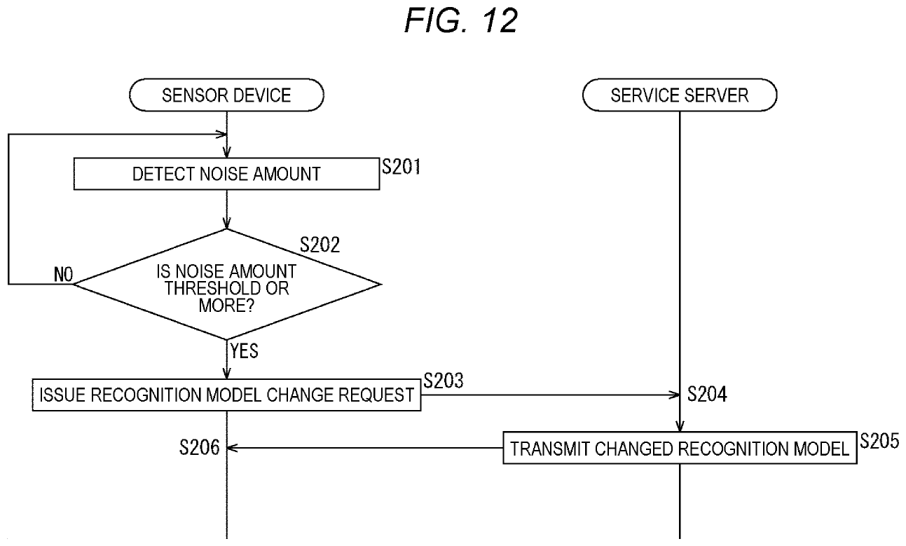

First processing related to the recognition model switching will be described. FIG. 12 is a flowchart for describing processing in a case where an instruction (request) is issued from the sensor device 10 side to start the recognition model switching.

In step S201, the noise detector 420 of the sensor device 10 detects the amount of noise. In step S202, it is determined whether or not the detected noise amount is a threshold or more. The process in step S202 is performed by the recognition model switching determination unit 440 of the sensor device 10.

In a case where it is determined in step S202 that the detected noise amount is not the threshold or more, the processing returns to step S201, and the processes in step S201 and subsequent steps are repeated.

Although the description has been given here by exemplifying the case where there are two modes of the normal mode (normal recognition model) and the noise-handling mode (noise recognition model), there may be two or more modes (recognition models at two or more noise levels). In a case where there are multiple modes, comparison with a threshold suitable for a mode set at a time point when the process of step S202 is performed is performed to perform the determination. That is, the threshold is set for each mode.

The processes of steps S201 and S203 are repeatedly performed at a predetermined cycle. The predetermined cycle may be every frame or every several frames. In a case where it is determined in step S202 that the sensed noise amount is the threshold or more, the processing proceeds to step S203.

In step S203, the sensor device 10 issues, to the service server 20, a mode change request, in other words, a request for a change to a recognition model according to the amount of noise. When receiving the mode change request from the sensor device 10 in step S204, the service server 20 sets a changed mode, and transmits the changed recognition model in step S205 in this case.

In step S206, the sensor device 10 receives the recognition model, for example, the noise recognition model from the service server 20, thereby transitioning to the noise-handling mode. Thereafter, the sensor device 10 starts processing based on the set recognition model. The processes of steps S203 to S206 correspond to the processes executed in steps S121 and S122 of FIG. 11.

In this manner, the sensor device 10 side can be configured to issue the mode change request.

<Second Processing Related to Recognition Model Switching>

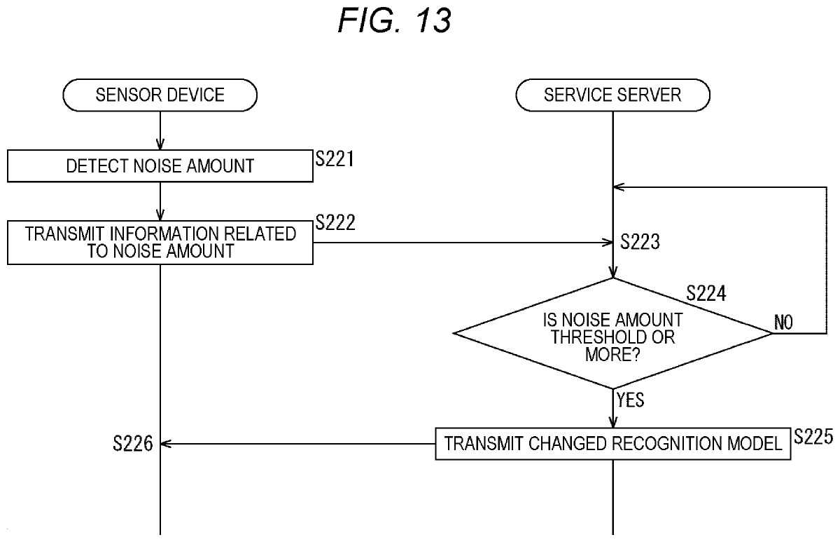

Second processing related to the recognition model switching will be described. FIG. 13 is a flowchart for describing processing in a case where the start of the mode transition is determined on the service server 20 side.

In step S221, the noise detector 420 of the sensor device 10 detects the amount of noise. In step S222, the sensor device 10 transmits information regarding the detected noise amount to the service server 20.

The processes of steps S221 and S222 are repeatedly performed at a predetermined cycle. That is, the sensor device 10 transmits the information regarding the amount of noise to the service server 20 every predetermined cycle, and the service server 20 receives the information regarding the amount of noise of the sensor device 10 every predetermined cycle.

In step S223, the service server 20 that has received the information from the sensor device 10 determines in step S224 whether or not the amount of noise of the sensor device 10 is a threshold or more. In step S224, in a case where it is determined that the amount of noise of the sensor device 10 is not the threshold or more, the service server 20 maintains the state as it is without performing any processing as the processing related to the mode transition.

On the other hand, in a case where it is determined in step S224 that the amount of noise of the sensor device 10 is the threshold or more, the processing proceeds to step S225. In step S225, a changed mode is set. Processes in and after step S225 are similar to the processes in and after step S205 (FIG. 12).

In this manner, it is possible to adopt a configuration in which the sensor device 10 transmits the information regarding the amount of noise to the service server 20 at the predetermined cycle, and the service server 20 side determines whether or not to change the recognition model, transmits the recognition model on the basis of the determination, and issues an instruction to start processing with the transmitted recognition model.

<Third Processing Related to Recognition Model Switching>

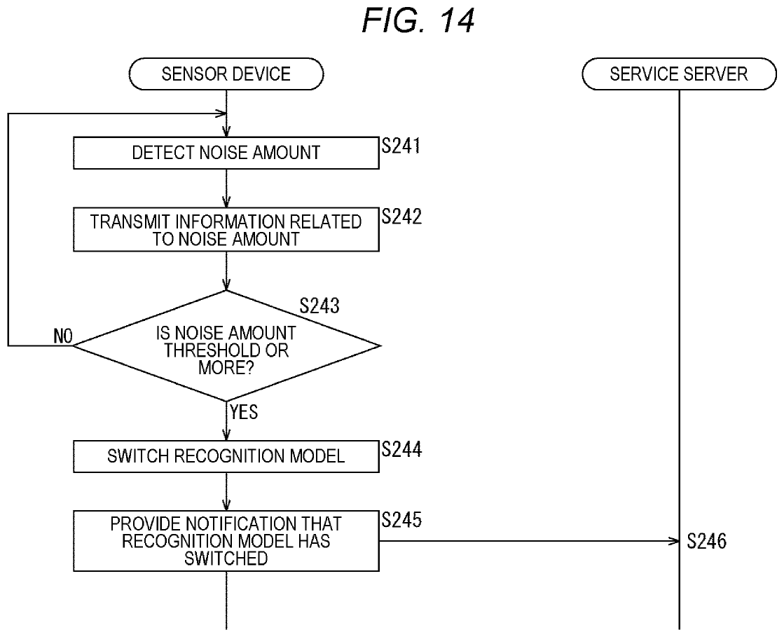

Third processing related to the recognition model switching will be described. FIG. 14 is a flowchart for describing processing in a case where the mode transition is completed on the sensor device 10 side.

The sensor device 10 may be configured to acquire and hold a plurality of recognition models from the service server 20 in advance. For example, the sensor device 10 can be configured to acquire and hold the normal recognition model and the noise recognition model from the service server 20 in advance. In a case where the plurality of recognition models is held on the sensor device 10 side as described above, it is also possible to adopt a configuration in which the recognition model can be switched only by processing on the sensor device 10 side.

Each of processes in steps S241 to S243 is similar to each of the processes in steps S201 to S203 (FIG. 12). In a case where it is determined in step S243 that the amount of noise is a threshold or more, the processing proceeds to step S244.

In step S244, the sensor device 10 selects a recognition model suitable for the amount of noise, and switches to the selected recognition model. Then, processing with the switched recognition model is started.

In step S245, the sensor device 10 notifies the service server 20 that the recognition model has been switched. This notification process can also be omitted. In step S246, the service server 20 receives the notification from the sensor device 10.

When receiving the notification, the service server 20 may execute a process of notifying, for example, an administrator who manages the sensor device 10 that noise is generated in the sensor device 10. Furthermore, when receiving the notification, the service server 20 may search for a more suitable recognition model than the recognition model that has been switched on the sensor device 10 side, and, in a case where the more suitable recognition model exists, transmit this recognition model to the sensor device 10.

According to the present technology, it is possible to switch to a recognition model suitable for the amount of noise generated in the sensor device 10 and execute processing with the recognition model suitable for the amount of noise. Thus, it is possible to perform processing while maintaining a state where the accuracy using the recognition model is high.

Although the description has been given in the above-described embodiment by exemplifying the case where the two recognition models of the normal recognition model and the noise recognition model are switched, the present technology can also be applied to a case where two or more recognition models are switched.

Furthermore, the description has been given here assuming that the recognition models are switched, but this recognition models may be recognition modes trained by the same learning algorithm, or may be recognition models trained by different learning algorithms. It is also possible to adopt a configuration in which a plurality of recognition models obtained by learning using different algorithms can be appropriately switched, for example, the normal recognition model being a recognition model obtained by learning using a deep learning technology, and the noise recognition model being a recognition model obtained by learning using the Adaboost technology.

Furthermore, the example in which the recognition model is switched according to the amount of noise has been described in the above-described embodiment, but the recognition model may be switched using an index other than the amount of noise. As the index other than the amount of noise, blurring, shaking, or the like of an image can be used. Furthermore, it is also possible to adopt a configuration in which a content of noise is analyzed to switch to a recognition model suitable for a characteristic of the noise.

Furthermore, when the amount of noise is calculated in the above-described embodiment, the amount of noise may be estimated according to luminance obtained from an illuminance sensor. For example, it may be estimated that noise is low in a case where the luminance obtained from the illuminance sensor is bright, and it may be estimated that noise is high in a case where the luminance is dark, and a recognition model may be selected and set on the basis of the estimation.

Although the description has been given in the above-described embodiment by exemplifying the case where the recognition model is switched, it is also possible to adopt a configuration in which not only the recognition model is switched, but also camera signal processing (parameters and the like for noise reduction processing, gain setting, and the like), for example, can be switched.

Furthermore, the recognition model may be switched for each installation place or scene. For example, in a case where the sensor device 10 is a vehicle-mounted camera, it is also possible to adopt a configuration in which, for example, a time of traveling inside a tunnel and a time of traveling outside the tunnel can be detected by using map information and GPS information to perform switching to different recognition models between the time of traveling inside the tunnel and the time of traveling outside the tunnel.

It is configured such that the noise recognition model is used inside the tunnel since it is dark and the amount of noise increases, and the normal recognition model is used outside the tunnel since it is bright and the amount of noise does not increase. The noise recognition model is switched to the normal recognition model, for example, when leaving the inside of the tunnel to the outside of the tunnel In this manner, it is also possible to adopt the configuration in which the amount of noise according to an installation position of the sensor device 10 is estimated and a recognition model suitable for the estimated noise amount is set.

<Regarding Recording Medium>

The above-described series of processes can be executed not only by hardware but also by software. In a case where the series of processes is executed by software, a program constituting the software is installed in a computer. Here, the computer includes a computer built in dedicated hardware and a general-purpose personal computer, for example, capable of executing various functions by installing various programs.

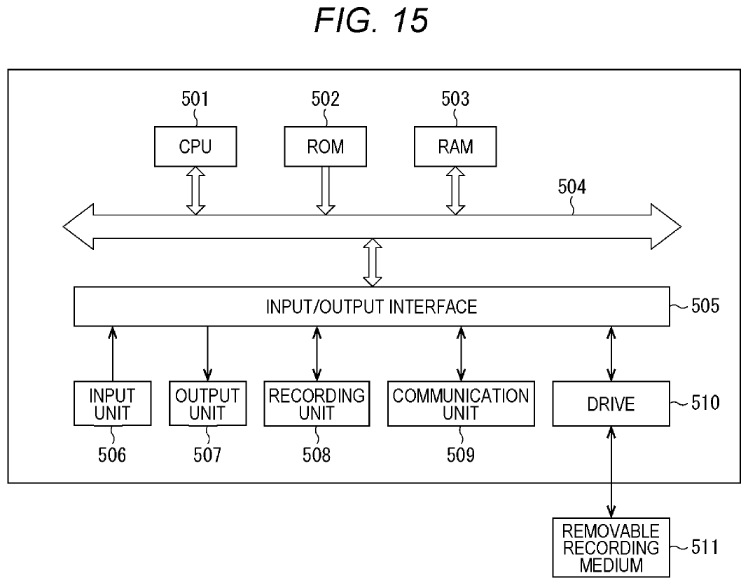

FIG. 15 is a block diagram depicting a configuration example of hardware configuration of a computer that executes the above-described series of processes according to a program. In the computer, a central processing unit (CPU) 501, a read only memory (ROM) 502, and a random access memory (RAM) 503 are mutually connected by a bus 504. Moreover, an input/output interface 505 is connected to the bus 504. An input unit 506, an output unit 507, a storage unit 508, a communication unit 509, and a drive 510 are connected to the input/output interface 505.

The input unit 506 includes a keyboard, a mouse, a microphone, and the like. The output unit 507 includes a display, a speaker, and the like. The storage unit 508 includes a hard disk, a non-volatile memory, and the like. The communication unit 509 includes a network interface or the like. The drive 510 drives a removable recording medium 511 such as a magnetic disk, an optical disk, a magneto-optical disk, and a semiconductor memory.

In the computer configured as described above, for example, the CPU 501 executes a program stored in the storage unit 508 in the state of being loaded on the RAM 503 via the input/output interface 505 and the bus 504, thereby performing the above-described series of processes.

The program executed by the computer (CPU 501) can be provided in the state of being recorded on, for example, the removable recording medium 511 as a package medium or the like. Furthermore, the program can be provided via a wired or wireless transmission medium such as a local area network, the Internet, and digital satellite broadcasting.

In the computer, the program can be installed in the storage unit 508 via the input/output interface 505 by mounting the removable recording medium 511 to the drive 510. Furthermore, the program can be received by the communication unit 509 via a wired or wireless transmission medium and installed in the storage unit 508. Furthermore, the program can be installed in advance in the ROM 502 and the storage unit 508.

Note that the program executed by the computer may be a program in which the processes are performed in a time-series order according to the order described in the present specification or may be a program in which the processes are performed in parallel or at necessary timing such as when a call is made.

<Application Example to Mobile Body>

The technology according to the present disclosure (present technology) can be applied to various products. For example, the technology according to the present disclosure may be achieved as a device mounted on any type of mobile body such as an automobile, an electric vehicle, a hybrid electric vehicle, a motorcycle, a bicycle, a personal mobility, an airplane, a drone, a ship, and a robot.

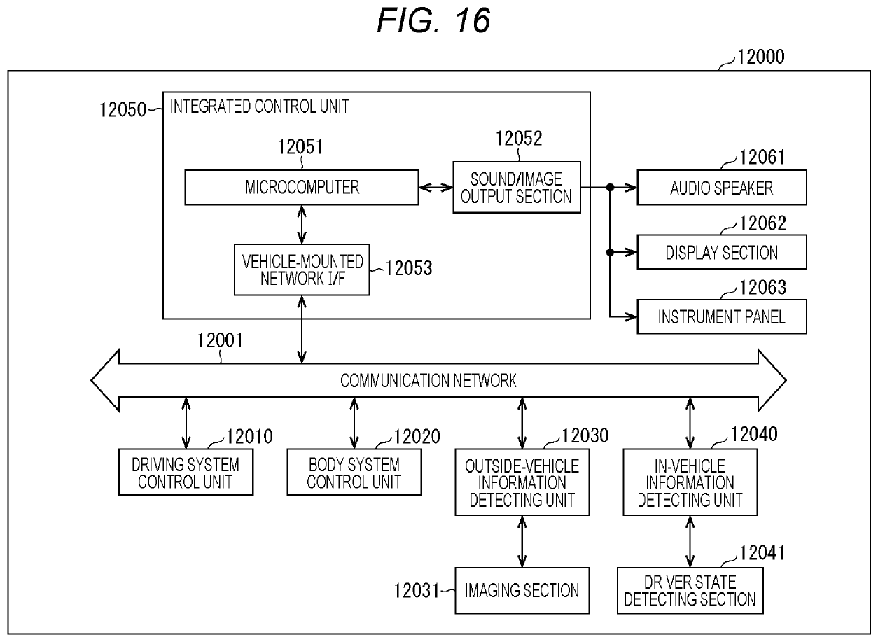

FIG. 16 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 16, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display and a head-up display.

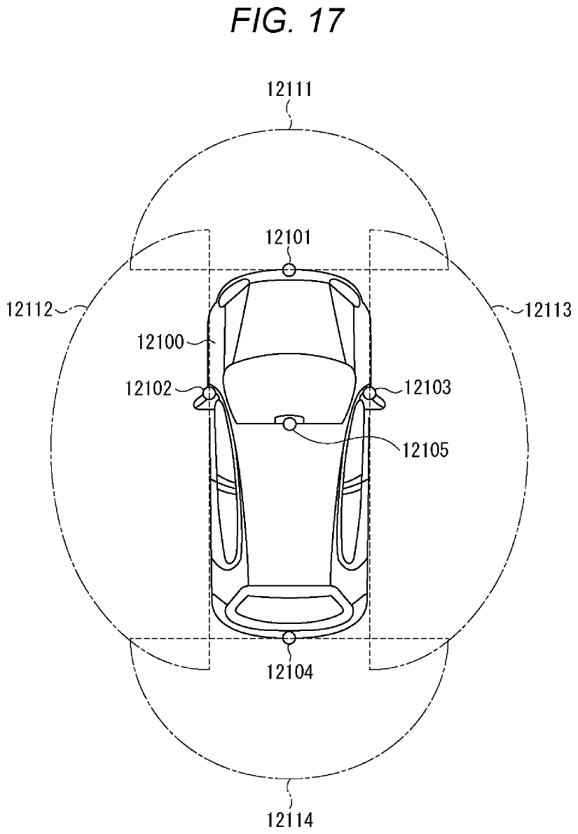

FIG. 17 is a diagram depicting an example of the installation position of the imaging section 12031.

In FIG. 17, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 17 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the present specification, the system represents the entire apparatus including a plurality of devices.

Note that the effects described in the present specification are merely examples and are not limited, and there may be other effects.

Note that embodiments of the present technology are not limited to the above-described embodiment, and various modifications can be made within a scope not departing from a gist of the present technology.

Note that the present technology can also have the following configurations.
(1)
An information processing apparatus including
a model switching unit that switches a recognition model according to an amount of noise of an imaged image,
in which the model switching unit switches between a first recognition model trained with an image without noise and a second recognition model trained with an image with noise.
(2)
The information processing apparatus according to (1), in which
the recognition model is used for processing by an artificial intelligence (AI) function.
(3)
The information processing apparatus according to (1) or (2), in which
processing using the first recognition model is performed in a case where the amount of the noise is a threshold or less, and processing using the second recognition model is performed in a case where the amount of the noise is the threshold or more.
(4)
The information processing apparatus according to any one of (1) to (3), in which
the amount of the noise is calculated by extracting a difference between the imaged image and an image obtained by performing a process of reducing the noise on the imaged image.
(5)
The information processing apparatus according to any one of (1) to (4), in which
the model switching unit requests another apparatus to set the second recognition model in a case where it is determined that the amount of the noise is a threshold or more.
(6)
The information processing apparatus according to any one of (1) to (4), in which
information regarding the amount of the noise is transmitted to another apparatus every predetermined cycle, and the recognition model is switched to the second recognition model transmitted from the another apparatus when it is determined that the amount of the noise is a threshold or more in the another apparatus.
(7)
The information processing apparatus according to any one of (1) to (6), in which
the first recognition model and the second recognition model are recognition models trained by different learning algorithms.
(8)
The information processing apparatus according to any one of (1) to (7), in which
when the recognition model is switched, signal processing is also switched.
(9)
The information processing apparatus according to any one of (1) to (8), in which
a content of the noise is analyzed to switch to the recognition model suitable for the noise.
(10)
The information processing apparatus according to any one of (1) to (3) and (5) to (9), in which
the amount of the noise is estimated using luminance measured by an illuminance sensor.
(11)
The information processing apparatus according to any one of (1) to (10), in which
the amount of the noise according to an installation position of a device that images the image is estimated to switch to the recognition model suitable for the estimated amount of the noise.
(12)
The information processing apparatus according to (5) or (6) being a sensor device that performs sensing, in which
the another apparatus is a server that acquires information sensed by the sensor device.
(13)
An information processing method including
switching, by an information processing apparatus, between a first recognition model trained with an image without noise and a second recognition model trained with an image with noise according to an amount of noise of an imaged image.
(14)
A program configured to cause a computer to execute a process of
switching between a first recognition model trained with an image without noise and a second recognition model trained with an image with noise according to the amount of noise of an imaged image.

### REFERENCE SIGNS LIST

1 Data distribution system
2 Service server
10 Sensor device
20 Service server
30 User device
40 Authentication server
100 Sensor unit
110 Positioning unit
130 Processing unit
132 ID transmission unit
134 Key reception unit
136 Sensor data acquisition unit
138 Pre-processing unit
140 Model acquisition unit
142 Recognition unit
144 Data generation unit
146 Distribution unit
160 Storage unit
170 Communication unit
230 Processing unit
232 ID transmission unit
234 Request acceptance unit
236 Capability information acquisition unit
238 Model generation unit
240 Model transmission unit
242 Data acquisition unit
243 Recognition unit
246 Distribution unit
260 Storage unit
270 Communication unit
302 Teacher data
310 Recognition model
400 Recognition model switching processing unit
420 Noise detector
422 Image input unit
424 De-noise processing unit
426 Difference extraction unit
428 Noise amount calculation unit
440 Recognition model switching determination unit
460 Recognition model switching unit

1. An information processing apparatus comprising
a model switching unit that switches a recognition model according to an amount of noise of an imaged image,
wherein the model switching unit switches between a first recognition model trained with an image without noise and a second recognition model trained with an image with noise.

2. The information processing apparatus according to claim 1, wherein
the recognition model is used for processing by an artificial intelligence (AI) function.

3. The information processing apparatus according to claim 1, wherein
processing using the first recognition model is performed in a case where the amount of the noise is a threshold or less, and processing using the second recognition model is performed in a case where the amount of the noise is the threshold or more.

4. The information processing apparatus according to claim 1, wherein
the amount of the noise is calculated by extracting a difference between the imaged image and an image obtained by performing a process of reducing the noise on the imaged image.

5. The information processing apparatus according to claim 1, wherein
the model switching unit requests another apparatus to set the second recognition model in a case where it is determined that the amount of the noise is a threshold or more.

6. The information processing apparatus according to claim 1, wherein
information regarding the amount of the noise is transmitted to another apparatus every predetermined cycle, and the recognition model is switched to the second recognition model transmitted from the another apparatus when it is determined that the amount of the noise is a threshold or more in the another apparatus.

7. The information processing apparatus according to claim 1, wherein
the first recognition model and the second recognition model are recognition models trained by different learning algorithms.

8. The information processing apparatus according to claim 1, wherein
when the recognition model is switched, signal processing is also switched.

9. The information processing apparatus according to claim 1, wherein
a content of the noise is analyzed to switch to the recognition model suitable for the noise.

10. The information processing apparatus according to claim 1, wherein
the amount of the noise is estimated using luminance measured by an illuminance sensor.

11. The information processing apparatus according to claim 1, wherein
the amount of the noise according to an installation position of a device that images the image is estimated to switch to the recognition model suitable for the estimated amount of the noise.

12. The information processing apparatus according to claim 5 being a sensor device that performs sensing, wherein
the another apparatus is a server that acquires information sensed by the sensor device.

13. An information processing method comprising
switching, by an information processing apparatus, between a first recognition model trained with an image without noise and a second recognition model trained with an image with noise according to an amount of noise of an imaged image.

14. A program configured to cause a computer to execute a process of
switching between a first recognition model trained with an image without noise and a second recognition model trained with an image with noise according to the amount of noise of an imaged image.
